(19) United States
(12) Patent Application Publication
(10) Pub. No.: US 2015/0263962 A1
(43) Pub. Date: Sep. 17, 2015

(54) METHOD FOR CONTROLLING DATA TRAFFIC BETWEEN A COMMUNICATION DEVICE AND A COMMUNICATIONS NETWORK VIA A COMMUNICATIONS LINK

(71) Applicant: Vodafone GmbH, Dusseldorf (DE)

(72) Inventors: Yalcin CAKMAK, Dusseldorf (DE); Steffen FIDELIUS, Neuss (DE)

(21) Appl. No.: 14/644,225

(22) Filed: Mar. 11, 2015

(30) Foreign Application Priority Data
Mar. 11, 2014 (DE) 10 2014 103 196.2

(51) Int. Cl. H04L 12/851

(52) U.S. Cl. CPC H04L 47/24

(57) ABSTRACT

The invention relates to a method for controlling data communications between a communication device (10) and a communications network (100) via a communications link (110), comprising the following steps:
monitoring all communication applications (20) on the communication device (10),
detecting a data communication request (22) of an active communication application (20),
comparing the active communication application (20) with at least one priority feature (24),
releasing, reducing or blocking a data communication (26) of the active communication application (20) based on the result of the comparison.

### RELATED APPLICATION

This application claims the benefit of priority of German Patent Application No. 10 2014 103 196.2 filed Mar. 11, 2014, the contents of which are incorporated herein by reference in their entirety.

### FIELD AND BACKGROUND OF THE INVENTION

The present invention relates to a method for controlling data traffic between a communication device and a communications network via a communications link, a computer program product for execution on a computer unit as well as a data control unit for a communication device in particular for performing a method according to the invention.

It is known, in principle, that communication devices such as mobile telephones, landline telephones, tablet PCs, laptops or similar wish to establish a communications link for the exchange of data. The exchange of data may comprise speech data, video data or any other form of data. To enable the exchange of data appropriate applications are frequently arranged and installed on the respective communication device. Applications on a device, which can, want to or shall perform a communication via a communications network, are, in terms of the invention, called communication applications. These may be programs installed on the communication device. In order to carry out a respective communication, with known communication devices this involves sending a respective data communication request to the communications network from a communication application. Subsequently this communications link is established enabling a data exchange to be carried out in one direction, in the other direction or bi-directionally. In any case, any data exchange between the communications network and the communication device is associated with so-called traffic, i.e. data traffic or data communications via the communications network.

The disadvantage with known methods and with known communication devices consists in that this data traffic is taking place essentially unchecked. In most cases communication devices are equipped, not with a single communication application, but with a plurality of the most varied communication applications. These may include, for example, mail programs, short message systems, video telephony programs, data exchange programs, cloud programs, music programs, and a great many other possible applications. Furthermore modern communication devices are able to run many communication applications in parallel on the communication device. For example, it is possible that the respective user is processing his emails or reading an email in the foreground of the display device of a communication device, whilst data synchronisation of short messages takes place in the background. Also it is possible for a radio service to perform a streaming service of an internet radio in the background. All these different communication applications send and receive data simultaneously, so that parallel data communication channels are opened between the communication device and the communications network. This is done at the cost of band width and latency of the respective data communications link, these two factors being exploited in order to gain a greater band width or a stronger latency. The effect of this may be that when the maximum band width or the maximum latency is reached, the user is faced with restrictions for individual communication applications. If for example a plurality of communications links are running in the background, this may have a negative influence on the quality of streaming services such as listening to an internet radio.

### SUMMARY OF THE INVENTION

It is the requirement of the invention to at least partially eliminate the above mentioned disadvantages. In particular it is the requirement of the present invention to improve the data link for the user and/or the network in a cost-effective and simple manner.

The above requirement is solved by a method with the characteristics of claim 1, a computer program product with the characteristics of claim 7 as well as a data control unit with the characteristics of claim 8. Further characteristics and details of the invention are revealed in the sub-claims, the description and the drawings. The characteristics and details described in conjunction with the method according to the invention naturally also apply in conjunction with the computer program product according to the invention and the data control unit according to the invention and vice versa, respectively, so that as regards the disclosure of individual aspects of the invention, reference is made or may be made either way.

A method according to the invention serves to control data traffic between a communication device and a communications network via a communications link. To this end the method according to the invention comprises the following steps:
monitoring communication applications, in particular all communication applications on the communication device,
detecting a data communication request from an active communication application,
comparing the active communication application with at least one priority feature,
releasing, reducing or blocking a data communication of the active communication application based on the result of the comparison.

Thus a method according to the invention interferes with the quality or the quantity of a data communication of an active communication application, which is being carried out. This interference takes place based on a comparison with at least one priority feature. A priority feature, in terms of the present invention, is understood to be an information which assigns the priority of usage to a specific communication application. The core of the priority assignment for the priority feature may comprise different origins. For example the priority feature may reflect the actual user wish. As such there may be priority features which are actively allotted by the user and therefore mark the communication applications which are most important to him. A device-specific prioritisation is also feasible for the priority features in terms of the invention. For example, it is possible to automatically award the highest priority feature to the communication application which runs in the foreground and is thus active on the display device of the communication device. It goes without saying, however, that functions on the network side may also form the basis for a prioritisation in form of priority features. In particular in a situation with two or more communication devices which together have established a data communications link with the communications network, such a network-side exchange may ensure a better user experience or a better network utilisation. For example a comparison may be undertaken of the priority features of two or more communication applications running in parallel, in terms of the method according to the invention.

A communication device in terms of the present invention is understood to encompass all devices which permit a data communication. This implicitly includes so-called landline devices, i.e. computers, tablets or landline telephones which are connected via a fixed cable with the communications network. The present invention as a whole has advantages in particular, if it is used for a radio communication device with a radio communications network. These are understood in particular, to be mobile communications networks and so-called WLAN networks in buildings or in public places. Short-distance radio systems such as a Bluetooth system or a so-called NFC interface (near field communication) can, of course, also be understood as a communication with a communications network in terms of the present invention.

By executing a method according to the invention it is then possible to weight individual communication applications or to assign a value to them. The decisive factor is that the priority features need not necessarily be fixed, but can be configured in a time-dependent, location-dependent or user-scenario-dependent manner based on the respective use of the communication application.

A method according to the invention may also be called a so-called session manager which acts like an internal router of the communication device. It prioritises the data rate or the communications links of individual communication applications and can move or adapt these individual weightings based on the comparison with at least one priority feature. How a method can be performed will now be described by way of example.

If the user of a communication device uses a communication application in the form of an internet radio on his data device, this may lead to the quality of the streaming service being used as the deciding factor for the priority feature. A restriction in comfort for a streaming service can be recognised very quickly when latency is exceeded, i.e. when the data transmission is jerky or too slow. This is very quickly perceived by the user as a deterioration in quality of the respective communications link. If at the same time communication applications are running on the same communication device in the background such as the retrieval of emails or other short messages, time-related delays, i.e. a reduction in latency of the data transmission, are non-critical for the feeling of comfort or quality to the user. Whilst with known solutions all communication applications, i.e. internet radio and email retrieval take place simultaneously at the same data rate, with the new method prioritisation becomes possible. In the chosen example, a respective data control unit can now perform a comparison with a priority feature and can detect that a latency-critical dependence exists with the communication application in the form of internet radio. Thus with this usage situation the internet radio as communication application is provided with a higher priority feature. As a result, with internet radio as the communication application, there will be an increase or release of the entire data communication, whilst parallel communication applications such as the retrieval of email or further short-messages are provided with a reduced or even blocked data communication and a corresponding priority feature.

The simple above-described example clearly illustrates, how by using a method according to the invention both the communications network and the communication device can be improved with regard to usage quality and user comfort. Thus for example for constant network quality, there is no need for providing additional network communications data width, in order to simultaneously improve or raise the feeling of comfort for the user in using the communication device.

According to the invention, a deciding criterion for the feeling of comfort or the feeling of quality for the communication device and for the communications network is in particular the data rate or the latency of the data rate. The data rate is understood to be the band width how many data packets can be sent simultaneously between the communication device and the communications network via the communications link. Latency is understood to be the time duration of these individual data packets, which is needed for the transmission. Whilst the data width is the deciding factor for the total quantity of data per time, latency is important for all communication applications, where time delays would mean interference with comfort. In particular this would be telephony, video telephony and so-called streaming services, where the user, through audio-visual perception, would immediately detect a delay in latency.

A data communication request is understood to mean that a communication application wants to establish a corresponding data communications link. This would also include to mean that an existing data communications link is possibly intended be altered. In particular an inventive data control unit to be described later is configured to continually execute the method according to the invention thereby performing quasi-continuous or completely continuous monitoring at regular intervals, in order to establish as to whether the current priority situation is still current based on the latest comparisons with priority features, which were carried out during the last pass of the method. It is easy to detect that over the usage duration the usage situation for individual communication applications or individual priority situations can change. This may take place in a time-dependent, usage-dependent, location-dependent or date-dependent manner, as will be explained in more detail below.

The monitoring of communication applications, in particular all communication applications on the communication device is intended to detect a data communication request. In this way the communication application can be monitored at intervals, partially continually or even continually. This monitoring, in particular, checks the communications interfaces of the communication applications for the start of a data transmission in the form of a data communication request.

The comparison with the priority feature and in particular also the location for storing the priority feature can be chosen freely. As such the priority feature may be already part of the respective communication application. Or the priority feature may be present, stored as a point in a priority list in the communication device. It is also possible for priority features and/or corresponding priority lists to exist on the network side in the communications network.

A method according to the invention thus provides a means to reduce a so-called unregulated data traffic also called burst traffic. The link quality felt by the user is focussed upon the communication applications which are currently most important to him and which are thus improved. At the same time the communications network is spared the load of unnecessary data traffic peaks and thus any time-related load distributions unnoticed by the user. Last but not least the invention has the advantage that a method according to the invention can be based, not just on one single communication device but on a plurality of communication devices. This also will now be illustrated by way of an example.

If for example one or more users, each with their own communication device, are logged into in a communications network, communications links between the communications network and individual communication applications are running on the respective communication devices. It may then happen that one of the users starts a particularly data-intensive service with a respective communication application. Using a method according to the invention this can be mapped such that a shift in the available band width or the necessary latency is shifted to the respective user provided with the corresponding peak data request and his communication device. In this way it is possible, also in a multi-user situation, for an existing band width in a network to improve the sensed link quality for all users of this communications network by a method according to the invention. For example for a streaming service used by one of the users on his communication device it is possible to estimate at which point in time he will have need for a correspondingly high peak of data for his communications link, for example because a picture with a lot of motion has to be transmitted in the stream. Since in this situation latency problems have usually also be taken into account, an appropriate adaptation or time-related buffering is possible either in advance or subsequently for this communication device or for the communication devices simultaneously registered in the same communications network.

A method according to the invention can of course ensure or optimise communication between different communication devices. In particular, this includes communications between a client and a server, between a server and a client as well as of course a communication between two servers.

A method according to the invention can be further developed so as to conduct the comparison of the active communication application with a priority feature of the communication application and/or of the communications network, in particular with at least one of the following priority features:
usage status of the communication application,
arrangement of the communication application on a display device of the communication device,
importance of the communication application for the user and/or for the communication device,
current status, in particular load situation of the communications network,
current time,
current date,
location of the communication device,
content and type of data of the data communication request,
user-specific information, in particular tariff option of the user.

The above listing is not a finite list. The user status of the communication application, for example, means that there is a difference between active and passive usage. For example, the user status may coincide with the time of opening/starting the communication application. An automatic opening of a session without user activity may be called passive usage, whilst an active selecting and starting of a communication application may constitute an active usage. If the communication application is arranged on a display device of the communication device this means that this communication application is present in the foreground on the display device. A communication application which is present in the foreground of a display device of the communication device, is normally the currently processed or used active communication application of the user. Possible problems with regard to link quality or deteriorated communications link are very clearly or immediately detected. Accordingly this information, because the communication application is present in the foreground, can cause an increase in priority with a corresponding priority feature. It is, of course, possible to also explicitly input the importance of the communication application. For example, the user can create his own lists in order to define for himself a corresponding importance of the communication application. He can for example place the importance of short messages above the importance of emails or vice versa. Also, with regard to the network or the device it is possible to provide individual communication applications with a higher or a lower priority. In this respect it is pointed out that in principle, with the present invention, each priority feature comprises an information which compared with other priority features allows weighting or valuing. As such, a priority feature may for example be a sequence of numbers or a sequence of letters so that it is unequivocally defined, which priority feature is to be estimated higher and which lower. For example a simple priority list may be provided which shows the importance in descending order. Double prioritisation is, of course, also feasible in terms of the present invention, so that different communication applications have equal valence and thus equal priority assigned to them through using corresponding priority features. Such priority conflicts can be resolved in that the same data rate or the same releasing, reducing or blocking is performed for these two communication applications. As current status in particular of a load situation of the communications network, there exists the currently used band width or the used and available latency for data packets. In this case explicit measuring or polling of the corresponding communications network can be performed. The current time, current date or location of the communication device can also have a direct or indirect influence upon the importance and thus the priority feature. The location of the communication device for example can point to a static position or a moving position. With moving positions the prioritisation assigned may be higher for navigation applications as communication applications than for static situations. Time and date are also feasible as an influence upon the priority feature. For example, prioritisation of communication applications may be different for midday, afternoon and evening. The content and type of the data communication request constitute of course also influential features which could be included in the priority feature. Here one should differentiate in particular with regard to how vulnerable the respective communication application is with regard to band width and/or latency. If speech data or streaming services are used, there will be a high dependency on latency thus allowing for a corresponding increase of the priority feature in this situation. Naturally a user-specific information, for example from the IMSI code, can also be used as information on the user. The corresponding tariff option of the user in particular, may be used as a corresponding prioritisation of individual communication applications.

It is also advantageous if with a method according to the invention the step of assigning a priority feature to a communication application by the user of the communication device and/or by the manufacturer of the communication device and/or by the operator of the communications network is performed at least once. Thus it can be recognised that the priority features may have different places of origin. The priority features may also be configured not only statically but also dynamically and in particular may include functions such as the influencing variables mentioned in the previous paragraph. As such it is possible, for example, for the users to input both static and dynamic and thus dependent importances as priority features for individual communication applications. The aim is for the priority features to fulfil the user's wish for the communication application or the communication device, or for the network side, to ensure a stability for the operator of the communications network with higher certainty.

It is also advantageous if with a method according to the invention the steps for at least two active communication applications, in particular for all active communication applications, are carried out. As already explained parallel prioritisations are of course also feasible. Such a prioritisation conflict is resolved in that communication applications having an equivalent priority feature at a point in time are treated in an equal manner. Thus for equivalent communication applications the same ranking order is used with corresponding release, reduction or blocking of the associated communications link.

Moreover it is advantageous if with a method according to the invention a priority feature is or is being assigned to the step of comparing the current communication application, and the assigned priority feature is compared with a priority feature of a further active communication application and/or from a priority list. The comparison in accordance with the method according to the invention leads to an explicit valence being able to be extracted for example from an existing priority list. But dynamic comparing is of course also feasible, where actively and for the respective usage period, a ranking order is specifically created for all active communication applications. A method according to the invention can thus be flexibly applied to essentially any conceivable usage situation of the communication device. Performing the comparison can of course take place both within the communication device and on the network-side within the communications network.

Moreover it is advantageous if with a method according to the invention, for the comparison step, the current display of the communication device is polled, wherein data communication is released if the current communication application is being displayed on the display. This is a particularly important decision criterion for the prioritisation with the aid of priority features. In particular communication applications which are arranged in the foreground and therefore are currently most likely to be used by the user of the communication device, are provided with a high or in particular with the highest priority feature.

Another subject of the present invention is a computer program product for execution on a computer unit, which is stored on a computer-readable medium. The computer program product comprises the following features:
computer-readable program means which cause the computer unit to monitor communication applications on the communication device,
computer-readable program means which cause the computer unit to detect a data communication request of an active communication application,
computer-readable program means which cause the computer unit to perform a comparison between the active communication application and at least one priority feature,
computer-readable program means which cause the computer unit to release, reduce, prioritise, accelerate, hold back or block a data communication of the current communication application based on the result of the comparison.

A computer program product according to the invention is used, in particular, to execute a method according to the invention. Accordingly a computer program product according to the invention includes the same advantages which have been described with reference to a method according to the invention.

A further subject of the present invention is a data control unit for a communication device, in particular for execution of a method according to the invention. The data control unit according to the invention comprises a monitoring interface for monitoring all communication applications of the communication device and detecting a data communication request of an active communication application. Further a comparison unit is provided for comparing the active communication application with at least one priority feature. In addition the data control unit comprises a control unit for releasing, reducing or blocking the data communication of the active communication application based on the result of the comparison. By using a method according to the invention a data control unit according to the invention comprises the same advantages which have been described with reference to a method according to the invention.

A data control unit according to the invention can be developed further by implementing it at least partially, in partially wholly, in an operating system of the communication device. In particular with a new purchase of or an upgrade to a new operating system, a communication device can thus be provided with a functionality according to the invention. This means that the lowest level within the communication device is reached thereby enabling an optimal intervention into the data traffic. Further an anchoring in the operating system is the best protection in order to be able to ensure against an undesired change.

It is also possible for a data control unit according to the invention to be installed at least partially, in particular wholly, as a computer program product in the communication device, in particular in a computer unit. As a result subsequent adaptation will be much easier. In particular a pre-installation by the manufacturer of the communication device or the respective provider of the communications network is thereby ensured. It is possible to permit an adaptation of the respective situation of the communication device to the respective provider.

A further advantage consists in that with a data control unit according to the invention this is configured at least partially, in particular wholly, as a downloadable computer program, in particular an app. In this way it is feasible for the user to subsequently, in particular actively, retrofit a communication device with the functionality according to the invention. Apart from a start of this retrofit by the user it is of course feasible for the respective provider of the communications network to start it.

It is also advantageous if with a data control unit according to the invention this is implemented at least on the communication device and partially in the communications network. This is understood to mean that a combination of different positions can provide the quality according to the invention. The data control unit can of course also be completely arranged in the communications network. According to the invention this division can essentially be freely performed so that depending on the arrangement of the data control unit, it is possible to ensure the same functionality for the entire system consisting of communications network and communication device.

### BRIEF DESCRIPTION OF THE SEVERAL VIEWS OF THE DRAWING(S)

Further advantages, characteristics and details of the invention are revealed in the description below, in which embodiments of the invention are described in detail with reference to the drawings. The characteristics mentioned in the claims and in the description may be essential to the invention individually or in any given combination. In the schematic drawings:

FIG. 1 shows a first embodiment of a communications network with communication devices according to the invention,

FIG. 2 shows an embodiment of a method according to the invention,

FIG. 3 shows a further embodiment of a method according to the invention, and

FIG. 4 shows a further embodiment of a method according to the invention.

### DESCRIPTION OF SPECIFIC EMBODIMENTS OF THE INVENTION

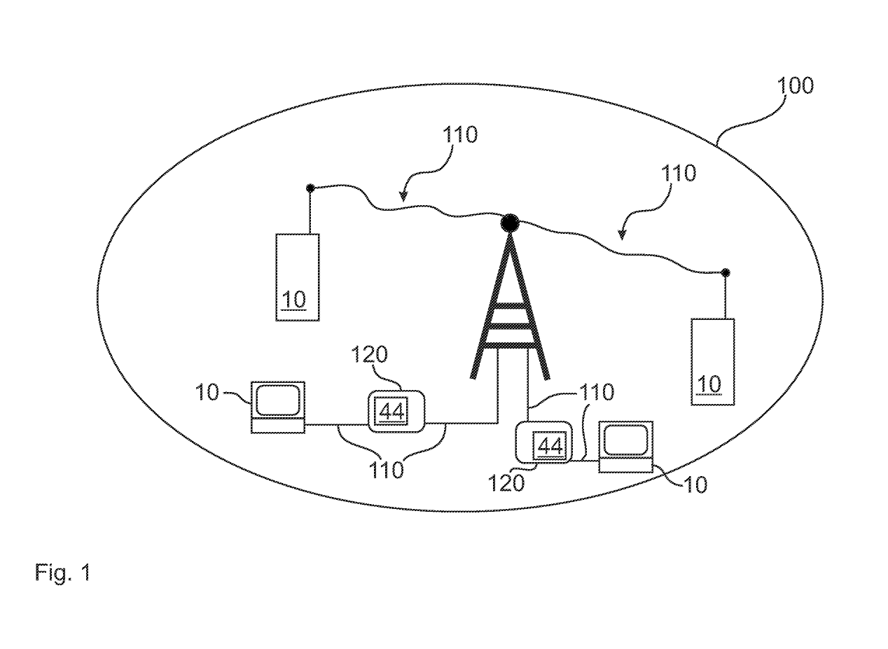

FIG. 1 schematically shows, how both mobile communication devices 10 in the form of mobile radio devices and stationary communication devices 10 in the form of computers can establish corresponding communications links 110 with a communications network 100. In the stationary situation exchange devices 120 are provided in the form of a so-called switch, in which a respective comparison unit 44 of a data control unit 40 not shown is present. In all cases communications links 110 are established for the exchange of data between the communications devices 10 and the communications network 100.

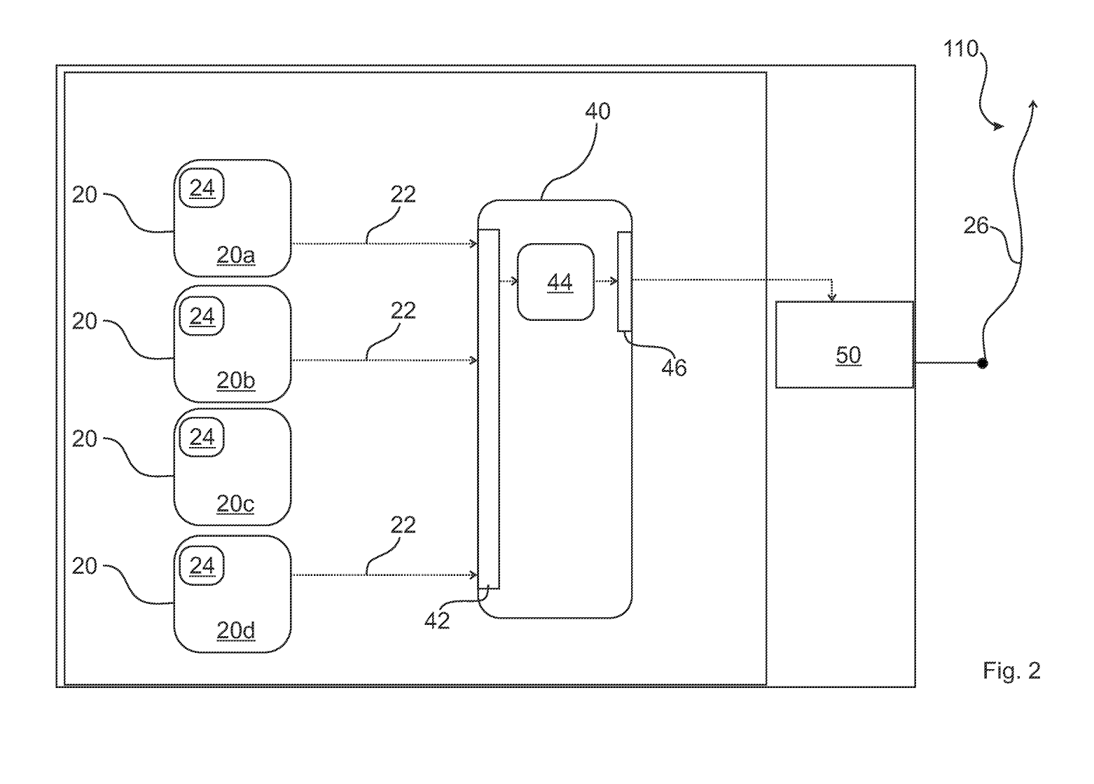

FIG. 2 schematically shows how a method according to the invention can proceed. A communication device 10 offers the possibility of establishing contact via a communications interface 50 in a data-communicating manner with the communications network 100 via a communications link 110. A plurality of communication applications 20, i.e. communication applications 20a, 20b, 20c and 20d, are arranged and installed in the communication device 10. In total, three of these currently installed communication applications 20, i.e. the communication applications 20a, 20b and 20d, simultaneously send a data communication request 22. This is detected by a data control unit 40 thus permitting to perform a comparison of the respective priority features 24 of the communication applications 20a, 20b and 20d in the comparison unit 44. The control unit 46 can now, based on the result of this comparison, perform a prioritisation of individual data communications 26 via the communications interface 50. If for example the communication application 20b is a streaming service, this will very likely have the highest priority feature 24. The other communication applications 20a and 20d are reduced accordingly and even completely blocked with regard to the requested data communication 26. With this embodiment the priority features 24 are assigned to individual communication applications 20 either by the user or by the communication device 10. The priority features 24 may be a function of different input variables so that depending on the time situation, usage situation, correlation with other active communication applications 20 or other parameters there may be a change in the individual priority features 24 based on these dynamic functions.

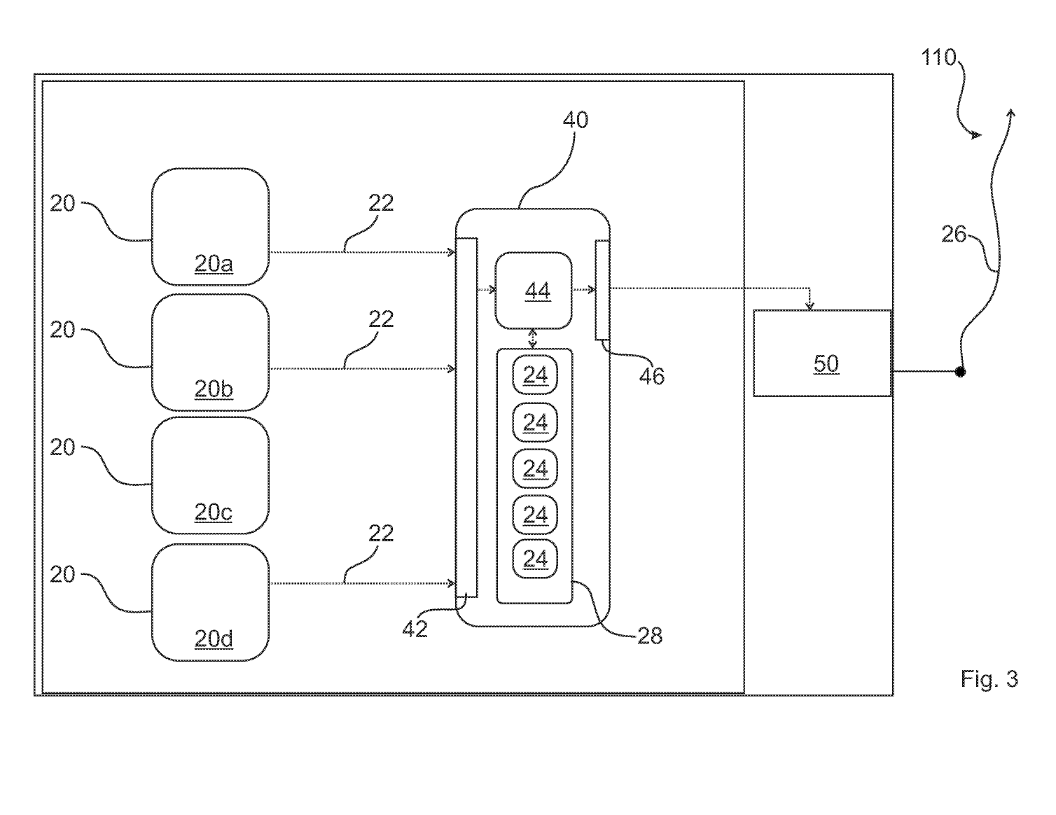

FIG. 3 shows a possibility where the priority features 24 are arranged outside individual communication applications. Here a priority list 28 is provided as part of the data control unit 40. Here again the data communication request 22 of the communication applications 20a, 20b and 20d is detected via the monitoring interface 42. Here again, due to a possibility of comparing the prioritisation with the priority list 28, blocking, releasing or reducing of the desired data communication 26 can now be effected via the communications interface 50. The function is identical with the function described witch reference to FIG. 2.

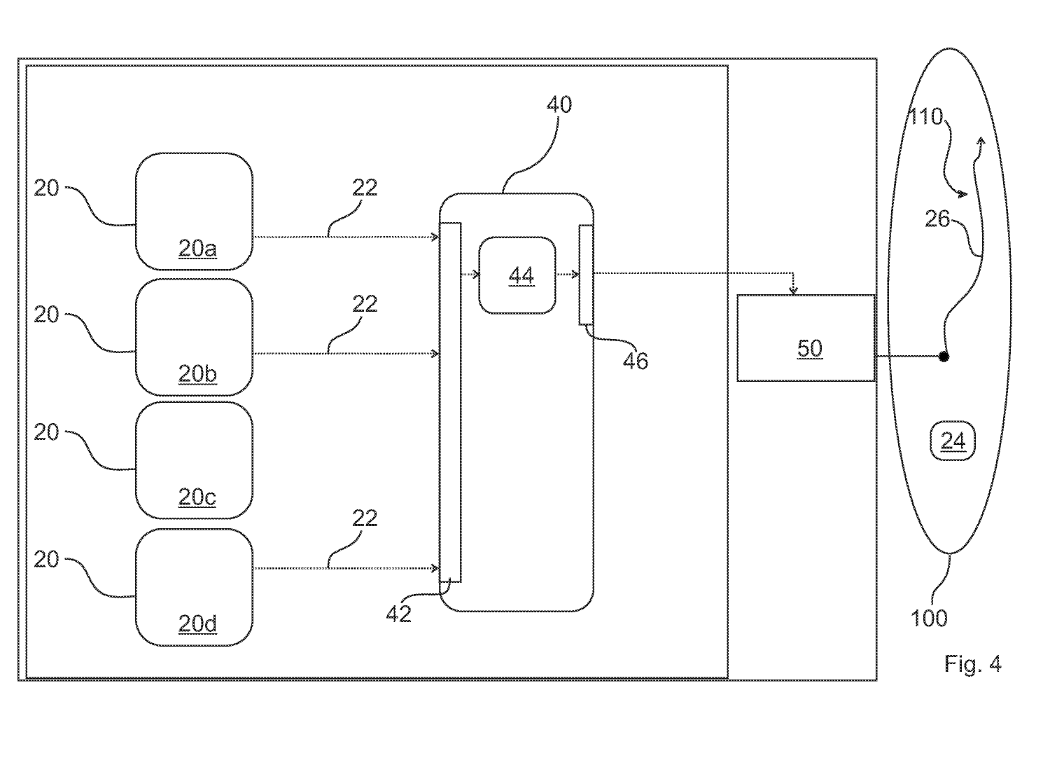

FIG. 4 shows the possibility of arranging the priority feature 24 or further priority features 24 externally in the communications network 100. Admittedly a comparison is in principle carried out in the comparison unit 44, but prioritisation is performed completely by the priority features 24 through the communications network 100. Thus access in particular for the operator of the communications network is very easy and in particular possible in a safe manner.

It goes without saying that the embodiments and above all the locations and assignment possibilities for the priority features 24 according to FIGS. 2, 3 4 can be combined with each other or with other alternative solutions.

The above explanations of the embodiments describe the present invention exclusively in terms of examples. Individual features of the embodiments, insofar as technically meaningful, can of course be freely combined without leaving the scope of the present invention.

### LIST OF REFERENCE NUMBERS

10 communication device
20 communication application
20a communication application
20b communication application
20c communication application
20d communication application
22 data communication request
24 priority feature
26 data communication
28 priority list
30 computer unit
40 data control unit
42 monitoring interface
44 comparison unit
46 control unit
50 communications interface
100 communications network
110 communications link
120 exchange device

What is claimed is:

1. A method for controlling data communications between a communication device (10) and a communications network (100) via a communications link (110), comprising the following steps:
monitoring communication applications (20) on the communication device (10),
detecting a data communication request (22) of an active communication application (20),
comparing the active communication application (20) with at least one priority feature (24),
releasing, reducing or blocking a data communication (26) of the active communication application (20) based on the result of the comparison.

2. The method according to claim 1, characterised in that the comparison of the active communication application (20) with a priority feature (24) is carried out, in particular, with one of the following priority features (24) of the communication application (20) and/or the communications network (100):
usage status of the communication application (20),
arrangement of the communication application (20) on a display device of the communication device (10),
importance of the communication application (20) for the user and/or for the communication device (10),
current status, in particular load situation of the communications network (100),
current time,
current date,
location of the communication device (10),
content and type of data of the data communication request (22),
user-specific information, in particular tariff option of the user.

3. The method according to claim 1, characterised in that the step of assigning a priority feature (24) to a communication application (20) is carried out at least once by the user of the communication device (10) and/or the manufacturer of the communication device (10) and/or the operator of the communications network (100).

4. The method according to claim 1, characterised in that the steps are carried out for at least two active communication applications (20), in particular for all active communication applications (20).

5. The method according to claim 1, characterised in that a priority feature (24) is assigned or is being assigned to the step of comparing the active communication application (20) and in that the assigned priority feature (24) is compared with at least one priority feature (24) of a further active communication application (20) and/or from a priority list (28).

6. The method according to claim 1, characterised in that for the step of comparing polling of the current display of the communication device (10) is carried out, wherein the data communication (26) is released if the active communication application (20) is currently displayed on the display.

7. Computer program product being stored on a non transitory computer readable medium, comprising:
non transitory computer readable program means to monitor communication applications (20) on the communication device (10),
non transitory computer readable program means to detect a data communication request (22) of an active communication application (20),
non transitory computer readable program means to perform a comparison between the active communication application (20) and at least one priority feature (24),
non transitory computer readable program means to release, reduce, prioritise, accelerate, hold back or block a data communication (26) of the current communication application (20) based on the result of the comparison.

8. A data control unit (40) for a communication device (10), in particular for performing a method with the characteristics of claim 1, comprising a monitoring interface (42) for monitoring communication applications (20) on the communication device (10) and for detecting a data communication request (22) of an active communication application (20), a comparison unit (44) for comparing the active communication application (20) with at least one priority feature (24) and a control unit (46) for releasing, reducing or blocking the data communication (26) of the active communication application (20) based on the result of the comparison.

9. The data control unit (40) according to claim 8, characterised in that this is implemented at least partially, in particular wholly, in the operating system of the communication device (10).

10. The data control unit (40) according to claim 8, characterised in that this is installed at least partially, in particular wholly, as a computer program product on the communication device (10), in particular in a computer unit (30).

11. The data control unit (40) according to claim 8, characterised in that this is configured at least partially, in particular wholly, as a downloadable computer program product, in particular as an app.

12. The data control unit (40) according to claim 8, characterised in that this is implemented at least partially on the communication device (10) and partially in the communications network (100).
